(19) United States
(12) Patent Application Publication
(10) Pub. No.: US 2013/0065082 A1
(43) Pub. Date: Mar. 14, 2013

(54) CONTAINER FIRE SUPPRESSION SYSTEM

(71) Applicant: KEVIN SOTO, Hidden Valley Lake, CA (US)

(72) Inventor: KEVIN SOTO, Hidden Valley Lake, CA (US)

(21) Appl. No.: 13/608,665

(22) Filed: Sep. 10, 2012

Related U.S. Application Data
(60) Provisional application No. 61/534,615, filed on Sep. 14, 2011.

(51) Int. Cl. B32B 15/01

(52) U.S. Cl. 428/665

(57) ABSTRACT

A cargo container fire suppression system may prevent fires from spreading within a cargo area into other portions of a craft. A fire resistant liner may be disposed within a cargo container to prevent a fire from penetrating through the liner and burning other elements within the craft beyond the wall(s) of the liner. The suppression system may include a fire sensor and an automatic fire extinguishing device. A transceiver may be coupled to the fire sensor which may remotely alert personnel to a fire occurring in the cargo area.

### CROSS-REFERENCE TO RELATED APPLICATIONS

This application claims the benefit of priority of U.S. patent application Ser. No. 61/534,615 filed Sep. 14, 2011, which is hereby incorporated by reference herein in its entirety.

### BACKGROUND OF THE INVENTION

The present invention generally relates to cargo systems, and more particularly, to a universal load device fire suppression system.

Millions of dollars of aircraft and property have been lost to cargo fires developing during transportation, especially in a load device, such as a universal load device (ULD). Aircraft cargo may typically be remote from the pilot or other aircraft personnel. Consequently, there is a delay in personnel knowing of a fire in the cargo hold and a delay in being able to put the fire out. In some cases, cargo aircraft have not been able to react soon enough to get back on the ground during in-flight fires.

As can be seen, there is a need for a fire suppression system that may recognize a fire and maintain the fire within a ULD for suppression.

### BRIEF DESCRIPTION OF THE DRAWINGS

FIG. 1 is a perspective side view of a cargo container according to an exemplary embodiment of the present invention;

FIG. 2 is a perspective top view of a base wall of the cargo container of FIG. 1;

FIG. 2A is a cross-sectional side view of a liner used in a wall of the cargo container of FIG. 1;

FIG. 3 is a top view of base wall of FIG. 2 sans the liner;

FIG. 4 is a side exploded view of a fire suppression system that may be used in the cargo container of FIG. 1 according to another exemplary embodiment of the present invention;

FIG. 5 is a side view of the fire suppression system of FIG. 4, mounted;

FIG. 6 is an internal front view of a control box of the fire suppression system of FIG. 4;

FIG. 7 is a side view of the control box of FIG. 6;

FIG. 8 is an exploded view of a sensor and control box of the fire suppression system of FIG. 5 without a fire suppression cylinder;

FIG. 9 is an internal rear view of the control box of FIG. 6 with an integrated battery;

FIG. 10 is a right side view of the control box of FIG. 7; and

FIG. 11 is a schematic diagram of an electrical circuit employed in the fire suppression system of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an exemplary embodiment of the present invention generally provides a fire detection and suppression system. An exemplary embodiment of the present invention provides an automatic fire detection and suppression system designed for a cargo craft to protect from a fire spreading amongst cargo containers. Another embodiment may include a liner designed to fireproof cargo containers so that if a fire occurs within a container, elements outside the container are protected. Also, if a fire occurs outside the container, the contents of the container may be protected from the exterior.

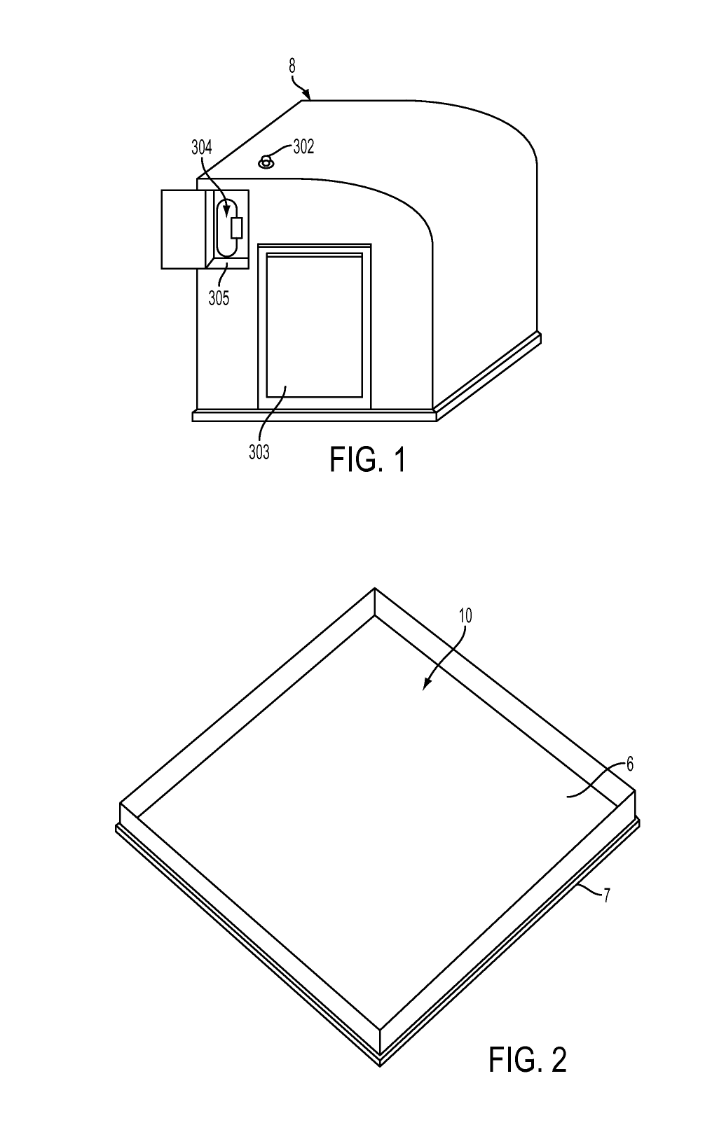

Referring now to FIG. 1, a cargo container 8 is shown according to an exemplary embodiment of the present invention. The cargo container 8 may be for example, a universal load device (ULD). The cargo container 8 may include, for example, steel walls and framing. The cargo container 8 may include a fire extinguisher 304 mounted inside a recessed mounting cabinet 305. In some embodiments, the extinguisher 304 may be protected behind a door of the cabinet 305. The cargo container 8 may include a roll-up type stainless steel door 303 allowing easy access to the interior. The cargo container 8 may also include a check valve 302 to relieve at least some pressure from within the cargo container 8, which may maintain a positive fire extinguishant environment. The check valve 302 may allow suppression gases to stay within while atmospheric gases are expelled. While the check valve 302 is shown on a roof of the cargo container 8, it will be understood that the check valve 302 may be placed on any of the walls.

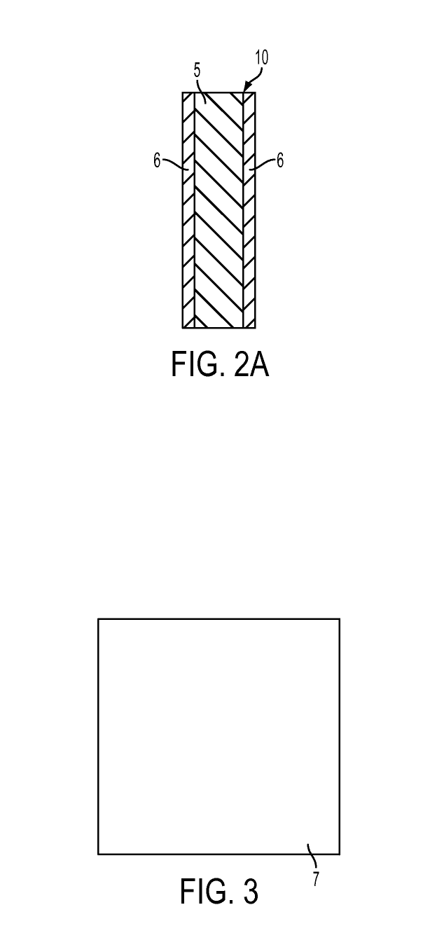

Referring now to FIGS. 2, 2A, and 3, various views of the interior lining of the cargo container 8 (FIG. 1) are shown. A liner 10 may be configured to resist fire and prevent fire from penetrating through the liner either from within the cargo container 8 or from the exterior of the cargo container 8. The liner 10 may include a heat resistant sheet of metal 5 positioned between two sheets of copper 6. The heat resistant sheet of metal 5 may be a metal with a melting point approximately above 1700°. In some embodiments, the liner 10 may be configured to resist or contain a class “D” fire. The heat resistant sheet of metal 5 may be thick enough to prevent fire from penetrating through the heat resistant sheet of metal 5. The heat resistant sheet of metal 5 may include for example tungsten. In some embodiments, the heat resistant sheet of metal 5 is entirely tungsten. The liner 10 may be disposed against an interior wall of the cargo container 8. For example, the liner 10 may be positioned over a base 7. The base 7 may be an aluminum pallet.

Thus, for example, when combustion occurs within the cargo container 8, fire may encounter the liner 10 before reaching any of the cargo container 8 walls. Fire may in some cases penetrate through the copper sheet 6 however the sheet of tungsten 5 may then contain the fire. It will be appreciated however, that by covering the sheet of tungsten 5 with copper, the tungsten may be protected from environmental contamination and degradation. For sake of illustration, the liner 10 is shown on the base 7 however it will be understood that the liner 10 may line any interior wall.

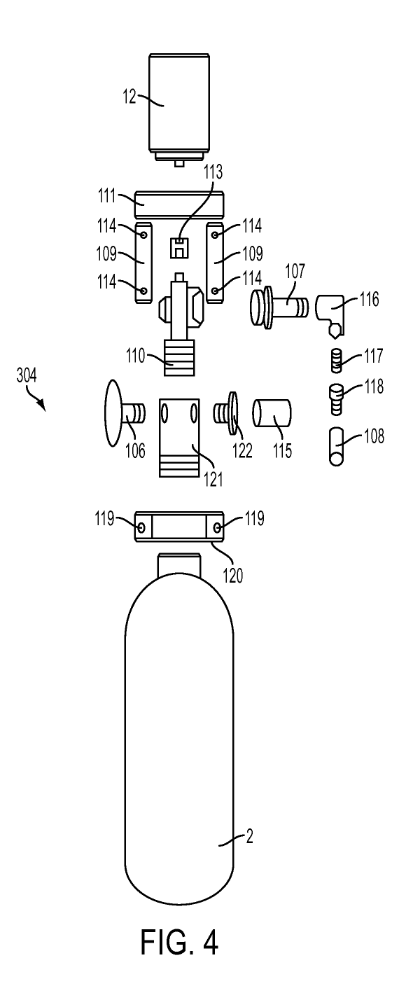

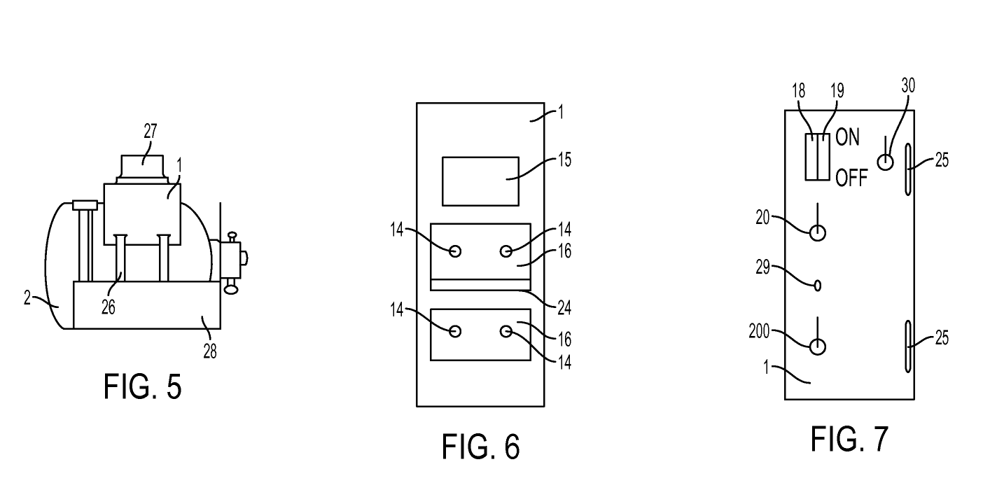

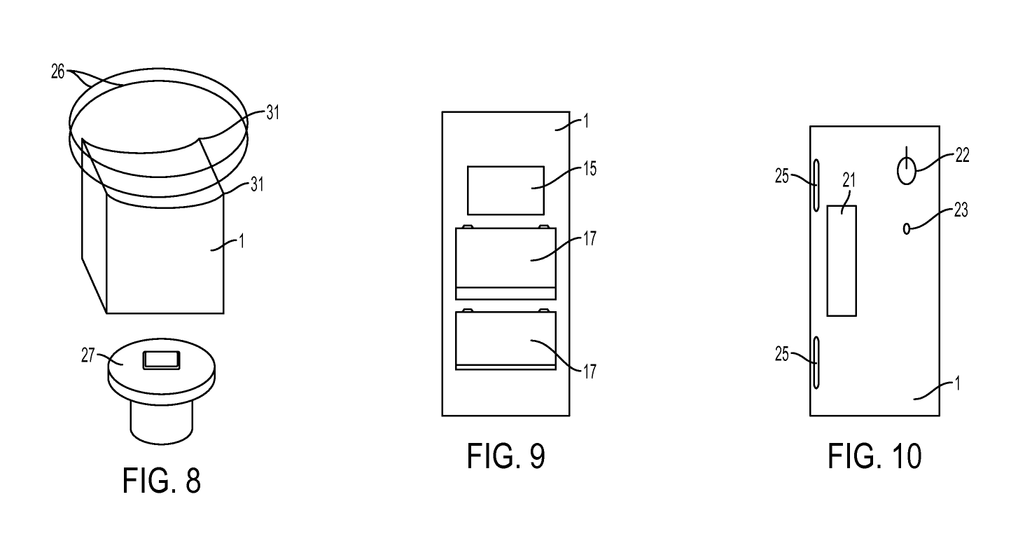

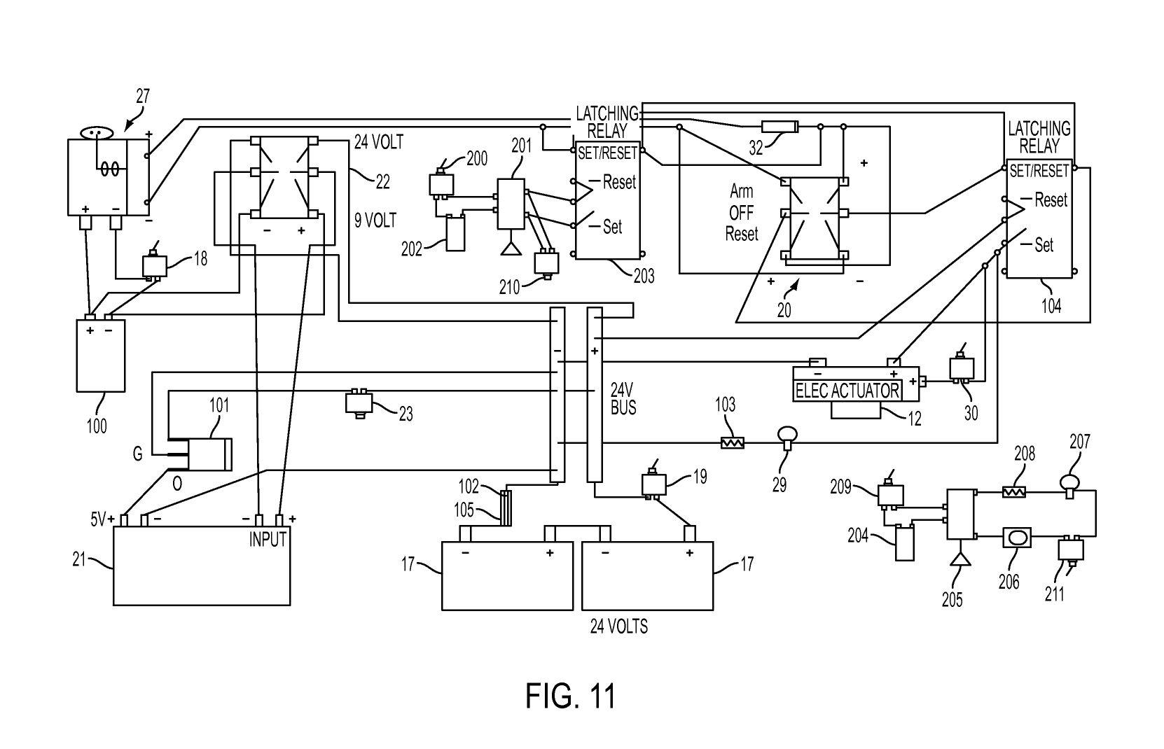

Referring now to FIGS. 4-11, a fire extinguisher 304 is shown along with an electrical schematic providing detail of electronic connections according to an exemplary embodiment of the present invention. The fire extinguisher 304 may include automatic fire detection and suppression functions.

The fire extinguisher 304 may include an electronic control box 1, which may house all electrical circuits and batteries. A fire detector 27 (sometimes referred to as the detector 27) may be coupled to the control box 1. In some embodiments, the detector 27 is a smoke detector or a heat detector. Control and activation of the detector 27 may be controlled by the control box 1. Detection of a fire by the detector 27 may activate release of a fire extinguishant. An electric actuator 12 may be used to electrically open and close a valve assembly 110 that releases the fire extinguishant housed within a cylinder 2. A chafe strip 31 may be added to the control box 1 to prevent chafing and keep the control box 1 in place with the cylinder 2. A personal computer board 15 inside the control box 1, such as a circuit controller with associated wiring, may be used to mount electrical control devices.

The cylinder 2 may be a pressure vessel installed to store fire extinguishant under pressure until ready for release. A cylinder mount 28 may be a mounting assembly to hold the pressure cylinder in place. A pressure gauge 106 may indicate amount of pressure inside the cylinder 2. A valve assembly adapter 107 may be screwed into a valve assembly 110 to allow a spray nozzle 108 to be attached.

The spray nozzle 108 may be attached to a valve assembly adapter 107 that atomizes the fire extinguishant upon release. A base coupler 109 may attach the actuator base 111 to the pressure cylinder neck adapter. An actuator base 111 may be a mounting bracket for the electric actuator 12. An actuator coupler 113 may transfer motion from the electric actuator 12 to the valve assembly 110.

An attaching hardware 114, such as a bolt, screw, washer, for example, may be attached to the actuator base 111. A spray deflector 115 may spread out and help atomize and disperse fluid flowing out of a heat fuse. A threaded pipe elbow 116 may be used for spray nozzle plumbing. A threaded pipe coupler may be used for spray nozzle plumbing.

A pipe threaded adapter 118 may be included for spray nozzle plumbing. A pressure cylinder neck coupler 120 may be attached to the pressure cylinder neck and the electric actuator base. The pressure cylinder neck adapter 121 may thread into pressure cylinder neck and become an extension of the neck, providing area for heat fuse 122 and the pressure gauge. The heat fuse 122 may be a melting fuse that allows the fire extinguishant to be released under certain atmospheric temperatures.

A main system battery tray 16 may be used to mount batteries 17 inside the control box 1. A detector power switch 18, such as an on/off power switch, may be installed for the detector 27. A fire suppression power switch 19, such as an on/off switch, may be used to engage the fire suppression extinguishant release. A reverse polarity switch 20 may have three position switches, for example, to reverse voltage from latching relay to reset system. The detector 27 may sense a fire and may start a relay effect that opens the pressure cylinder 2 while providing an alert to people, such as aircrew via a transmitter 201. A fire suppression discharge light 29 may alert ground crews that the discharge of the extinguishant has occurred. An actuator reverse switch 30 may allow the actuator 12 to reverse and be placed back into an armed position.

A voltmeter 21 may be used to monitor system voltage of the detector 27 and electronic control system. A voltage test switch 22 may apply power to the voltmeter 21 for monitoring system voltage. A rubber battery insulation pad 24 may be used to insulate a battery 17. Strap retention slots 25 may be formed in the control box 1 for holding strap 26 that may retain the pressure cylinder 2.

A diode 32 may be placed into electrical circuit to remove AC current. A detector battery 100 may supply main power to detector 27. A voltage regulator 101 may be installed to provide proper voltage for voltmeter 21. A fuse 102 may be installed to provide proper voltage for light emitting diode (LED) light. Latching relay 104 may be installed to operate as power relay for the electric actuator, triggered by the detector 27.

Some of the electrical components may be mounted on the PC board 15, which in turn may be mounted in the electronic control box 1. The detector 27 may be powered by the detector battery 100, through the detector power switch 18. The detector 27 may sense the smoke or heat which sends a DC voltage signal to a latching relay 104 through a reverse polarity switch 20 and diode 32. The reverse polarity switch 20 may be used to reverse the polarity of the battery to reset the latching relay 104.

Once the latching relay 104 detects the voltage from the detector 27, the latching relay 104 may latch and close the circuits from the main system batteries 17 through the fire suppression power switch 19, the fuse 102, the fuse holder 105, and power the electric actuator 12 open. The actuator reverse switch 30 may be installed to switch the electric actuator 12 to a closed position.

To make sure all circuits are powered properly, a battery test function may be developed. This may consist of a voltmeter 21, powered by a voltage regulator 101. The voltage regulator 101 may receive an electrical signal from main system batteries 17 through a voltage test switch 22 and push to test switch 23 to selectively test each battery voltage.

The main system batteries 17 may be mounted in the control box 1 with two main system battery trays 16 with an attaching hardware 14. The lower main system battery 17 may be protected from accidental shorting by a rubber battery insulation pad 24 under the upper battery-mounting tray 16. The electronic control box 1 may be mounted to the pressure cylinder 2 through strap retention slots 25 with control box retaining straps 26 and the chafe strips 31 between the electronic control box 1 and the pressure cylinder 2.

A fuse holder 105 may be installed to mount the fuse 102 into the electric circuit. A transmitter power switch 200 may be installed to control the on/off power for a transmitter 201. The transmitter 201 may be installed to send signal to the receiver 205 to alert the user of possible fire hazard and the extinguishant has been released.

A transmitter battery 202 may be the main power source for the transmitter 201. A latching relay 203 may be associated with the transmitter 201 that closes the circuit on the transmitter 201 to send a warning signal, which is triggered by the detector 27. A push to test switch 210 may allow an operator to test the transmitter 201 without triggering the latching relay 203.

A receiver battery 204 may be the main power source for receiver 205. The receiver 205 may be installed, for example, in a cockpit, to receive a warning signal from the transmitter 201. The receiver 205 may have a light and buzzer warning for the user alerting the user of an overheat and/or smoke condition existing in the cargo area. The receiver buzzer 206 may alert users to the possibility of a fire hazard.

The receiver LED 207 may be installed to alert a user to a possible fire hazard. The receiver resistor 208 may be added to the LED circuit to create a proper voltage. A receiver power switch 209 may be installed to control the on/off power for the receiver. A receiver arm or disarm switch 211 may be installed in the LED or buzzer circuit to disarm or shut off the fire hazard warning.

The transmitter 201 may be powered by the detector battery 202 through the transmitter power switch 200. When triggered, the latching relay 203 may close and cause the detector input circuit to send signal to the receiver 205. The receiver 205 may be powered by the receiver battery 204 through the receiver power switch 209. When triggered, the receiver 205 may produce an electrical current that energizes the receiver buzzer 206 and the receiver LED 207 through the receiver resistor 208 and the receiver arm or disarm switch 211. The trigger power source for the entire 24 volt mechanical system may be a replaceable 9 volt battery, which may keep this system in a state of low maintenance and high reliability.

When smoke or heat is introduced to the detector 27, this may trigger an electrical signal which may be sent to two latching relays. The first latching relay may close a circuit that allows the electric actuator to open the valve assembly 110 and release the fire extinguishant. The second latching relay may close a circuit that allows the transmitter 201 to transmit a signal to the receiver 205 which illuminates a light and sounds a buzzer. If the detector 27 is attached to a computer, the computer may control the electric actuator to release the fire extinguishant and send the signal to the receiver 205 via the transmitter 201.

An exemplary embodiment of the present invention may be used to suppress airborne fires, for example, in modified ULDs. Once the ULDs are modified according to an exemplary embodiment of the present invention, a fire extinguisher 304 may be mounted inside the ULD and turned on and armed. The detector 27 and the receiver 205 may be turned on and armed. The early-warning transmitter 201 and receiver 205 may let, for example, a pilot know as soon as a fire erupts and may provide valuable time to get the aircraft on the ground to prevent in-flight catastrophe.

It should be understood, of course, that the foregoing relates to exemplary embodiments of the invention and that modifications may be made without departing from the spirit and scope of the invention as set forth in the following claims. For example, while the foregoing has been described in the context of protecting cargo, embodiments of the present invention may be placed inside storage rooms to protect property and homes during natural disaster, such as forest fires.

What is claimed is:

1. A cargo container liner, comprising:
a first sheet of copper;
a sheet of tungsten; and
a second sheet of copper, wherein the sheet of tungsten is positioned between the first and second sheets of copper.

2. The cargo container liner of claim 1, wherein the sheet of tungsten is configured with a thickness to prevent fire from penetrating therethrough.

3. The cargo container liner of claim 1, wherein the liner is adapted to line an interior wall of a cargo container.

4. A cargo container liner, comprising:
a sheet of heat resistant metal positioned between two sheets of copper, wherein the liner is adapted to line an interior wall of a cargo container.

5. The cargo container liner of claim 6, wherein the sheet of heat resistant metal has a melting point above 1000° C.

6. The cargo container liner of claim 7, wherein the sheet of heat resistant metal includes tungsten.
